(19) United States
(12) Patent Application Publication
(10) Pub. No.: US 2003/0229611 A1
(43) Pub. Date: Dec. 11, 2003

(54) Mapping, navigation, and data input for electronic documents

(76) Inventor: Michael Hintenach, Reinholds, PA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/166,016

(22) Filed: Jun. 10, 2002

(51) Int. Cl. G06F 17/30

(52) U.S. Cl. 707/1

(57) ABSTRACT

The invention provides methods, systems, programs, and apparatus for, among other things, viewing, reviewing, managing, editing, mapping, navigating, inputting data to, receiving data for, and completing electronic documents such as e-forms. For example, methods, systems, and programs that enable users to access and review electronic documents and maps of electronic documents, to navigate from one document or one document page to another, to enter data into documents, or even move to unrelated applications, and return to previous documents without losing or compromising data previously entered, and to monitor the status of completion of the documents. The invention is fully compatible with computer networks such as the Internet, and with other public and private electronic communications systems such as local and wide area networks (LANs and WANs), whether wireless, hard wired, or of any other form.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

The invention disclosed herein relates generally to navigation, mapping, and input of data for electronic documents. In particular, the invention relates to methods, systems, programs, and apparatus for mapping, navigating, viewing, reviewing, filling, editing, revising, and completing electronic forms. The invention has broad application in electronic communications and data input, collection, and transfer, including commercial and educational applications.

The popularity and wide applicability of computers has fostered the development of increasingly complex electronic data structures, including for example data files used to build electronic forms adapted for interactive gathering of data such as sales or rental agreements, registration forms, and interactive polls. The gathering of data through the use of electronic forms, both via locally controlled and network-implemented applications, is commonplace. For example, organizations such as commercial ventures and government agencies have developed and rely on standardized electronic documents, such as electronic forms, to gather data more efficiently for applications for loans, leases, sales, school admissions, etc.

Methods and systems for navigating through electronic documents are disclosed in U.S. patents and International Publications. For example, U.S. Pat. No. 6,292,188 to Carlson et al. discloses system and method for navigating in a digital information environment, including a navigation bar that is spatially structured so that content pages can be located relative to one another.

U.S. Pat. No. 6,144,962, to Weinberg et al. is a part of a family of patents that discloses methods and systems for visualization of web sites and hierarchical data structures, including a program for generating a site map which graphically depicts the overall architecture of a web site.

WIPO publication no. WO 01/22245 in the name of Bannen discloses a dynamic navigation tool bar incorporating real-language context addressing, including a customizable graphical user interface for enabling users to navigate to hierarchically associated web sites wherein real-language context addresses have been substituted for uniform resource locator (URL) or domain name codes.

WIPO publication no. WO 01/44991 in the name of Saravanan discloses system and method for network navigation. A computer receives page instructions for displaying a first web page, the page instructions including application instructions for displaying an application on the first web page, storing the application instructions, receiving new page instructions for displaying a second web page, determining if the second web page includes the application, and formatting the second web page for display based on the new instructions and, if the second web page includes the application, on the application instructions.

U.S. Pat. No. 5,963,208 to Dolan et al., discloses integrated network access user interface for navigating with a hierarchical graph, including a navigation tool wherein a user accesses information by selecting a graphical representation of an item from the hierarchical graph.

U.S. Pat. No. 6,178,433 to Nakamura et al. discloses method and system for generating materials for presentation on a non-frame capable web browser. A graphic user interface presents a table of contents listing various selectable web pages stored in a single file.

U.S. Pat. No. 5,933,841 to Schumacher et al. discloses a structured document browser including a user interface for displaying and viewing sections of documents that are organized according to predefined structure.

U.S. Pat. No. 5,958,008 to Pogrebisky et al. teaches software systems and associated methods for scanning and mapping dynamically-generated web documents.

U.S. Pat. No. 6,145,003 to Sanu et al. teaches a method of web crawling utilizing address mapping.

The Free Application for Federal Student Aid (FAFSA) website of the United States Department of Education, at www.fafsa.ed.gov, enables a user to complete a multi-page electronic form, and to move backward through already-completed pages. A navigation tree is presented on the currently-displayed page. Users are not able to move ahead from one page to the next until all data requested by the current page is entered. The navigation bar does not float as a separate window or reflect the status of partially-completed pages.

There exists, however, need for improved methods, systems, programs, and apparatus for receiving input for, navigating, and mapping of electronic documents.

For example, a common problem for users of computer programs adapted for collecting data, such as web-based applications for completing registration, sales, and training forms, is that the users sometimes forget where they are within a lengthy or complex document structure. This can be especially harmful for network-based or other stateless implementations of document input applications, in that data entered on one page or for one document is often lost when a user moves back to a previous page and attempts to return to a subsequent page, or moves temporarily to an entirely separate application and then attempts to return to the first.

In stateless systems such as the Internet and other computer networks, the user of a document or forms application is often at risk of interrupting the flow of the application presenting the document by, for example, selecting a hypertext or other navigation link, selecting a bookmark or other navigation aid, including the backspace key, or moving to another computer address (e.g., a user resource listing, or URL). The interruption of this flow can cause difficulties such as loss of previously-entered data, or of program processes altogether, as for example, when a program times out and ends.

### BRIEF SUMMARY OF THE INVENTION

The invention addresses these and other concerns. The invention provides methods, systems, programs, and apparatus for, among other things, viewing, reviewing, managing, editing, mapping, navigating, inputting data to, receiving data for, and completing electronic documents such as e-forms. For example, methods, systems, and programs that enable users to access and review electronic documents and maps of electronic documents, to navigate from one document or one document page to another, to enter data into documents, or even move to unrelated applications, and return to previous documents without losing or compromising data previously entered, and to monitor the status of completion of the documents. The invention also enables users to move to separate documents or applications without losing data through timing out or other termination features implemented by applications. The invention is fully compatible with computer networks such as the Internet, and with other public and private electronic communications systems such as local and wide area networks (LANs and WANs), whether wireless, hard wired, or of any other form.

In some embodiments the invention provides methods, programming, etc., useful for navigating within an electronic document, monitoring the status of completion of input requests within the document, and other purposes. In this aspect the invention provides computer systems and computer readable media having computer programming stored thereon for causing a computer system to display on a computer display, such as a terminal display screen, a map of a plurality of related electronic documents. The documents comprise a plurality of associated data input requests, and the map includes an indication of the status of the data input requests.

An electronic document (a “document”) is a data structure adapted, when interpreted by a computer process, for imparting information to a computer user, and optionally for receiving data from a computer user, or otherwise collecting or gathering data. An electronic document can include, for example, data and/or coded instructions or processes for causing a computer interface screen to present to a user a set or collection of information in such form as to enable the user to perceive or understand a set of one or more data requests and to input requested data to the computer in such form that the computer can use the data for computing or data processing processes, or store the data for use by other computers and/or processes.

An electronic page (or simply a “page”) is a data structure which when interpreted by a computer process presents for a user a document reviewable by the user at one time, without substantial reading and/or writing of data from permanent or indefinite storage.

A document can include one or more pages or sections intended for presentation together or in association with each other. For example, a document can include a single-page electronic form intended for presentation on a user computer screen and for interactive collection of data related to, for example, a loan application; or a document can comprise multiple forms or pages or sections. Because each of the pages, or subdocuments, or sections, is intended for a single purpose, and for presentation together or otherwise in association with each other, the pages collectively are considered a plurality of related documents. A single document may also comprise a number of pages, and may be related to other documents having one or more pages. For example, an application for a student loan may be associated with, and mapped with, a student registration or registration application form, an insurance form, a book order forms, and the like.

A single document comprising multiple pages and a document set comprising multiple documents are, for purposes of this disclosure, synonymous.

Documents are related when, for example, it is desired or intended that they be associated for purposes of collecting or receiving data, or any purpose pertaining thereto.

A computer user can include a human being or another computer or computer process.

Often the computer system on which the invention is used is controlled by one or more operating system programs. For example, it is anticipated that the invention will be implemented on one or more computers using a windows-type operating system such as those available through Microsoft. Thus some embodiments of the invention further comprise programming for causing the computer system to display a map of a set of related documents in a window distinct from any window or windows used for input of data in response to data requests associated with the documents. That is, in some embodiments of the invention the document set map is displayed in a separate window. Optionally in such embodiments the map window is always displayed in its entirety, regardless of the size, shape, or content of any other window; or is optionally so displayed, as for example at the selection of a user of the computer system. Preferably windows in which document maps are displayed are subject to control operations such as moving the window from one location to another on the display screen, resizing the window, “shrinking” or minimizing the window into a representative graphic icon, and restoring the window to a previous display state through the use of simple commands such as those commonly used with windows-type operating systems.

Maps of document sets according to the invention may be displayed in any form suitable for imparting to the user the information the user desires or requires in order to understand the structure of the document set, or the status of input for the document set. For example, the map may comprise a table outlining the document set, with suitable titles or headers for individual documents, document sections, pages, or other indices. Such tables or outlines may be either text or icon based, and in either case may comprise selectable links, such as hypertext links, and associated programming for causing the computer system to display at least a portion of a document when the link identifying or otherwise associated with the document is selected by the user.

Optionally maps in such embodiments comprise indications of whether each of the documents has been displayed, and/or is currently displayed, as for example by presentation of a check mark or other suitable symbol, or by changing the color or appearance of the text or icon associated with the link.

Preferably, embodiments of the invention comprising maps which include an indication of the status of the data input requests include an indication of the level of completion of status requests associated with each document. For example, in embodiments in which the map comprises a separate text header or icon associated with each document, a color-coded symbol or text message may be associated with the text header or icon, the symbol or text message indicating whether each document has been visited, started, or completed, or is incomplete.

Optionally, where the document set comprises documents or data requests some aspects of which are contingent upon satisfaction of some condition(s) associated with other documents within the set, the fact of and/or nature of the contingency are indicated in the map. For example, where it is necessary to complete one or more data requests associated with a document prior to allowing display of or access to a subsequent document by the user, the dependent document can be unshown or otherwise unrepresented in the map, or the existence of the dependent document may be shown in the map by listing the document in a more subdued or otherwise distinguishable appearance prior to satisfaction of the contingency criteria. Once the contingency criteria have been met, the appearance of the icon or text associated with the subsequent document may be changed. For example, so long as a dependent document is not accessible by the user, a text-based hypertext link in the map may be shown in a reduced size or otherwise less prominent font, and then, when the contingency criterion(a) have been satisfied and the document is accessible, the link may be changed to a bolder or larger format of the same type as that used for displaying otherwise accessible documents. Or a document may not be displayed or displayable at all until the contingency criteria have been met and the document is accessible to the user.

Some embodiments of the invention provide methods, systems, programming, etc., for causing a computer system to display, successively or simultaneously, portions of documents within a set of related documents; to receive data inputs for input fields displayed as part of or otherwise associated with the various documents; and to allow a user to move back and forth, accessing the documents and filling in data or reviewing information within the related set of documents; to or navigate outside the document set, without losing data previously entered, so that data received for documents is still valid upon the user's return to the document set. Preferably such embodiments further cause the computer system to display indications of the status of completion of data fields within the documents. These embodiments are especially useful where the computer system comprises a server and one or more user terminals. Data used for building and displaying documents can be stored in memory associated with the server, and used by the user terminal(s) to display the documents, while data received for the various input fields associated with the displayed documents can be stored in memory associated with the user terminal until the data entry process is complete and a complete data set is ready for use by the application for which the documents have been provided. Optionally data used in building and displaying the documents may be read from the server by the user terminal, and stored in memory associated with the user terminal, while the data entry process proceeds.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 is a flowchart of a computer system suitable for use in implementing the invention.

FIG. 2 is a flowchart of a preferred embodiment of a process for navigating and entering data for a set of electronic documents, and for monitoring the status of input requirements for the documents according to the invention.

FIG. 3 is a schematic diagram of an alternate preferred embodiment of a process for navigating and entering data for a set of electronic documents, and for monitoring the status of input requirements for the documents according to the invention.

FIG. 4 is a schematic diagram of a display screen window according to a preferred embodiment of the invention.

FIG. 5 is a schematic diagram of a display screen window according to a preferred embodiment of the invention.

### DETAILED DESCRIPTION OF THE PREFERRED EMBODIMENTS

Preferred embodiments of methods, systems, and apparatus according to the invention are described through reference to the Figures.

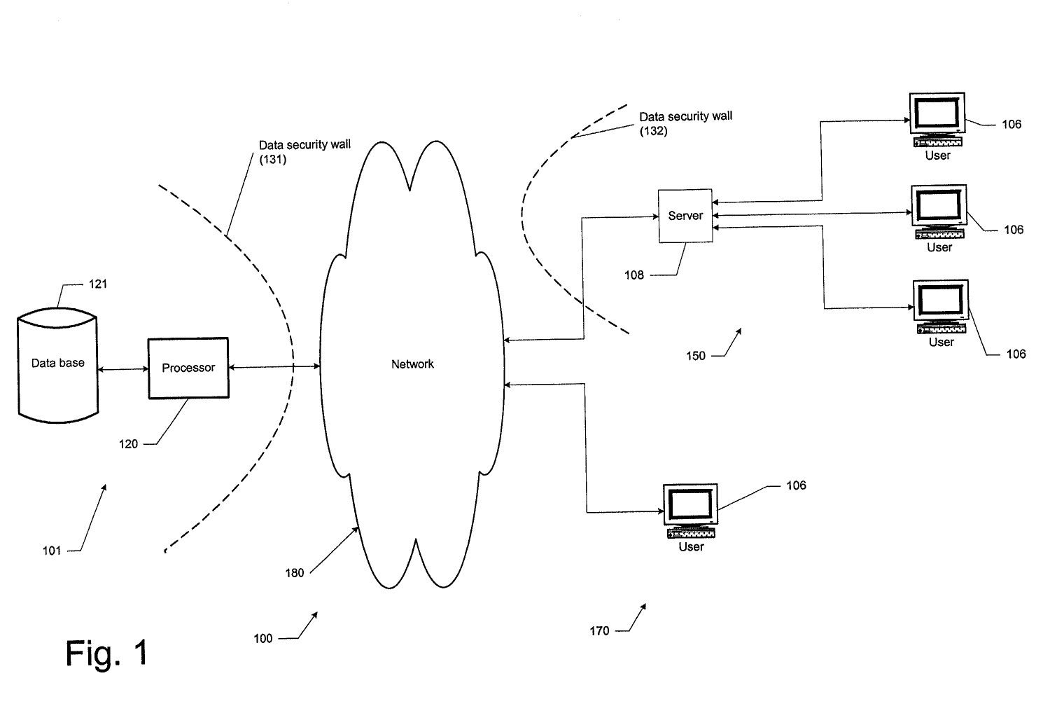

FIG. 1 is a schematic diagram of a computer system suitable for use in implementing the invention. System 100 is a combination of systems 101, 150, and 170. System 101, a network server system, comprises processor 120 and data base 121. System 150, a client LAN architecture, comprises server 108, which comprises a processor and associated memory (not shown), and a plurality of user terminals 106 such as personal computers or workstations. Each of systems 101, 108, 106, and 170 comprise a processor and associated computer memory suitable for the purposes described herein. Systems 101, 150, and 170 are connected via network 180, which may comprise any suitable computer networking means or devices, such as for example the Internet, the World Wide Web, or any private or public electronic communications networks, whether wired, wireless, or otherwise. Systems 101 and 150 comprise optional data security walls 131, 132, and other conventional and/or desirable features. Any of systems 101, 150, 170, and/or 106, alone or in combination with others, is suitable for implementation of the invention.

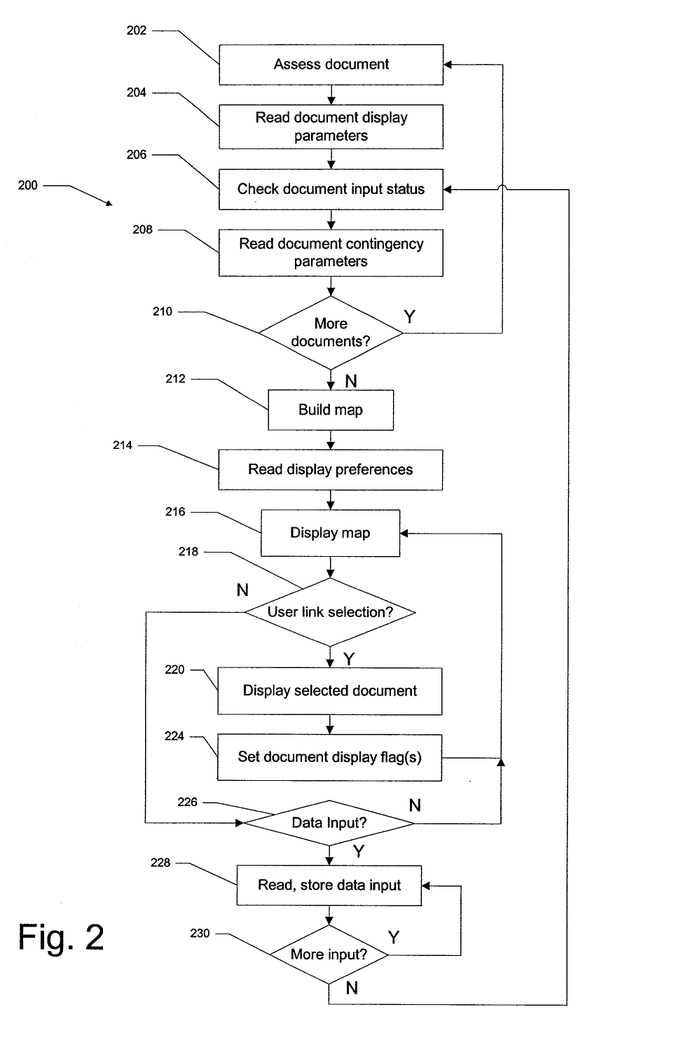

FIG. 2 is a flowchart of a preferred embodiment of a process for navigating and entering data for a set of electronic documents, and for monitoring the status of input requirements for the documents according to the invention. The process of FIG. 2 is suitable for implementation on any of the systems 101, 150, 170 and/or 106 of FIG. 1, and on a large variety of other automatic data processing systems. Among other things, process 200 of FIG. 2 enables the building of a map of an entire accessible document structure, so that a user can see and navigate through an entire document, and enter data in the order and manner most convenient to the user.

Process 200 of FIG. 2 begins at 202 with an assessment by the computer system of the first of a set of related documents. This assessment comprises identification of the document, as for example by identification of a memory address where the document data may be found or from which the document data may be accessed. This may be initiated in a number of ways. For example, a user of the computer system may guide the system to the initial document, as for example through keypad entry or pointing device selection of known or previously-identified URLs or other memory or document addresses; or the computer system may use a number of automatic processes such as those taught in the cited prior art documents to search out such addresses. Each of the references cited herein is hereby incorporated in full for this purpose, as though set forth in full herein. Guiding users in the use of active guidance procedures and/the implementation of automatic processes such as web crawlers or other automatic navigation and search systems for identifying and assessing documents will be well within the skill of the designer of ordinary skill, once the designer has been made familiar with this disclosure.

When the document has been identified, relevant properties of the document are assessed. This can include, for example, the length, type, and size of the document, and whether any authorizations are required for access. Any relevant document information having been assessed, at 204 document display parameters are read and stored as required. These may be set interactively by a user, or automatically by the computer or any processes running thereon; set by default, overrideable by the user or otherwise; or read from previously-established data files or records. Display parameters can include an identifier such as a title text header and/or the length of the document, the format(s) in which the data is stored (e.g., .jpg, .htm, or any other data type or combination of types). They can also include a user's preferred display format, such as colors, font types and sizes, window size, etc. Generally with regard to this aspect of the invention the display parameters associated with a document are used in building a map of the document and/or the set of documents for which the gathering of data is desired.

At 206 the computer system checks the document's input status. For example, by reading suitable data sets and comparing stored data inputs, if any, with data input requirements, the computer system determines whether any data has been entered, whether any additional data is required to complete the document, and, if so, how much. This data is used for displaying with the map of the document set an indication of the input status of each document.

At 208 the computer system determines whether the current document is subject to any contingencies with regard to other documents, or whether any other documents are subject to contingencies with regard to it. For example, one document may not be accessible by a user until one or more given items of data are entered by the user in response to requirements of another document. Data indicating these contingencies are stored for use in building the document map.

At 210 the computer system determines whether any more documents in the target document set are available. For example, a list of documents in the set, compiled by the user or by an application associated with the computer system, can be consulted, or web-crawling or other active searching techniques may be applied. If further documents are available, process items or steps 202-208 are repeated until all desired documents have been accessed and reviewed, and required data stored.

Once all desired documents for the set have been accessed, the collected data is used at 212 to construct a map of the document set. For example, a table of document titles or headers is compiled, with input status indicators associated with individual headers.

At 214 any display preferences set by the user, the system, or both are determined. For example, the user can specify which terminal or computer display the map will be displayed upon, and select colors, fonts, table styles, window sizes, locations, etc.; or these can be set by the computer system; or they may be set as defaults and overridden by the user.

At 216 a map of the document set is displayed on a computer screen, in accordance with the preferences determined at 214. Preferably addresses for data files useable for displaying documents belonging to the set are associated with representations, such as text strings, icons, or the like, of the documents to be displayed, and are displayed as part of the map. For example, URLs or other addresses can be used to build hypertext or other links to the various documents within the set, and displayed as part of the map. Optionally, display flags are set to a default value to indicate that none of the documents has yet been displayed, and the undisplayed status of each of the documents is indicated in the map, as for example by a particular color for a text identifier or icon representing the document.

The map having been displayed, the user is enabled to navigate and, if the user so desires, to begin to supply data to complete the mapped documents. At 218 the user selects a link for a desired document. Using the address associated with the link, the computer accesses the data file(s) associated with the selected document and causes the computer system to display the document in a location selected by the user.

At 220 the system displays the selected document.

At 224 the display flag associated with the document is changed to indicate that the document has been displayed and/or, if appropriate, is currently the displayed document; and at 216 the map is updated and redisplayed. Process items 216-224 are repeated until the user has navigated to a desired document.

When the desired document is displayed, at 218 the computer, not having read a user link selection at 218, waits for data input. At 226, if data is input, the computer at 228 receives the input, as for example, by reading from a TTY buffer in an interactive application, and stores it in a suitably tagged or addressed location for later use in a separate application.

At 230 the computer checks for more input until an indication is received that no more input is to be received. For example, a user, having completed all data entry required for a page, can push an “enter” button on a standard computer keyboard, or can select another link in the displayed map to move to another document. When a determination is reached that no more input is to be received for a given document, at 206 the document input status is updated and process steps 208-216 are repeated until an updated map is displayed.

The process continues in the manner described until an indication is received that the user is finished entering data, or some other action occurs to terminate the process. For example, a time limit may be set for idle time, that is, time in which no input is received by the application; at the end of an inactive period of specified duration the process can terminate. Upon termination control can pass to a separate application, such as an application for processing the data just entered; or the process may simply terminate.

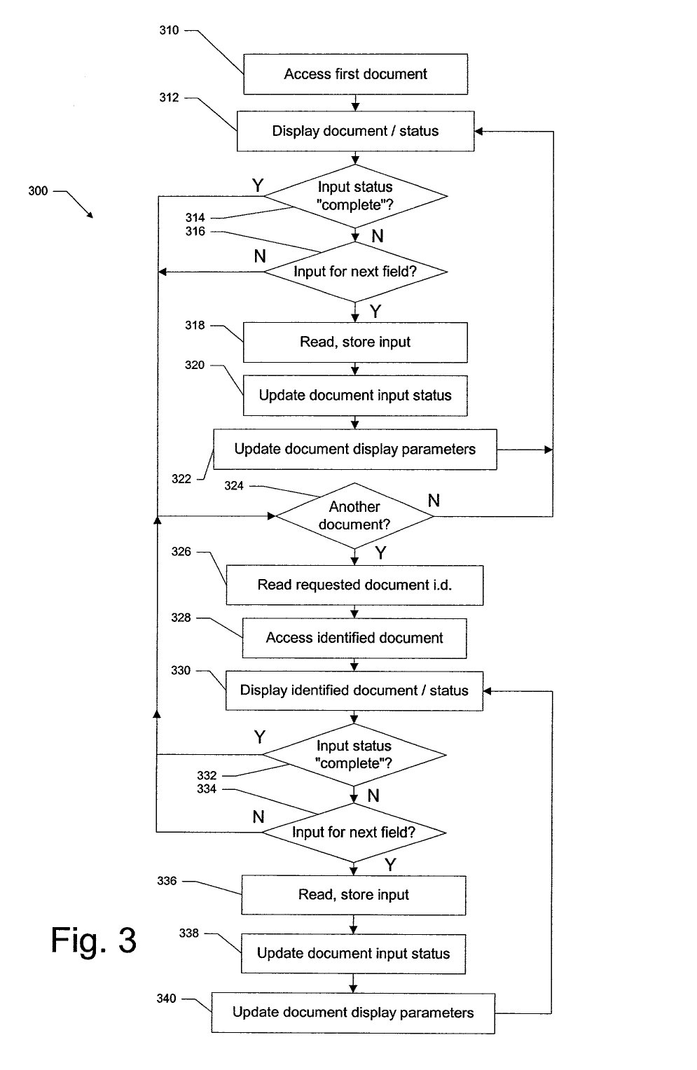

FIG. 3 is a flowchart of an alternate preferred embodiment of a process for navigating and entering data for a set of electronic documents, and for monitoring the status of input requirements for the documents according to the invention, suitable, for example, for implementation on any of the systems shown in FIG. 1, or on any combination thereof. Among other things, process 300 of FIG. 3 enables a user to navigate freely through a document set, reviewing the document and entering data in the manner most convenient to the user, without losing data, and to build a map useful for navigating the document while doing so.

Process 300 of FIG. 2 begins at 310 with assessment of the first of a set of documents. The set of documents, and information regarding the addresses and formats of data files associated with the document set, can be predetermined, as for example in a data file provided by the document provider, or document identities can be supplied by the user or other source on a document-by-document basis. Optionally the computer, upon accessing the first document, determines whether the document comprises any data requests, and if so whether any data satisfying the requests has already been received.

At 312 the first document is displayed, with an indication of the input status of the document.

At 314 the input status of the document is checked. If all required inputs for the first document have previously been received, or if no inputs are required, at 324 it is determined whether another document from a defined set remains to be displayed, or has been requested by the user. If unsatisfied input requests remain, at 316 a check is made to determine whether input has been received from the user. If no input is received, the user may be prompted; otherwise at 324 a check is made to determine whether another document is set for display or requested. If input has been received, at 318 it is read and stored.

Data may be stored either locally or remotely, and either within or outside the application used to display the document and receive input. For example, a stand-alone computer can be used to display a set of documents, such as a training course, and to receive data representing answers to training questions in response to requests made in the document display. All document data can be stored in memory associated with the stand-alone computer, and may be stored as part of the training program itself or as part of a separate navigation application, as for example an extension of a standard browser. Similarly, input data may be stored locally or remotely. For example, where a user is viewing and entering data for a remotely-stored application such as a lease or purchase agreement accessed via the Internet, input data may be stored in memory associated with the user's own computer or remotely, in memory associated with the application host computer; and storage, navigation and/or data input may be accomplished via a part of the application program or through a stand-alone program such as an appropriately-coded browser. Preferably, the data is in any case retained as valid input to the relevant document(s) as the user moves through the documents, and is not lost through for example being dumped from a buffer. This can be accomplished, for example, through reading and storage of document set data structures, program objects etc., as for example is done through current cookie or flash applications.

Saving of data in this fashion, so that it remains valid input for processes intended to use data collected by documents, allows the user to navigate from a document page to other areas of the Internet without completing the transaction, by not filling in all of the fields required by the application, without losing data. This can prevent the user from becoming lost, or forgetting what they were doing in the original application when they try to return and complete data input for the document. It can also be used to prevent timing out and associated data loss.

When data is read and stored, at 320 the input status for the document is updated and at 322 any appropriate updates in display parameters are made. For example, a notation or other indication may be made in the document display to show that data for a particular field has been received.

At 312 an updated representation of the document is displayed.

The process between 312-322 repeats until all required data has been received for the document or until a determination is made that no other input is coming, or that another document is desired.

Upon determination at 324 that another document is desired, and receipt of a requested document identity at 326, at 330 a process of displaying the document, requesting and receiving additional data, and displaying an updated version of the document at 332, 334, 336, 338, and 340, is initiated. This process is generally similar to the process 310-322.

Processes 310-322 and 324-340 repeat, with various documents selected by the user, until the user has entered all desired input. It is important to note that a single document may be accessed, and data entered, and if desired replaced, more than once, at the initiative of the user or according to any requirements of the application providing the document.

Optionally process 300 terminates when a user provides a command indicating that the process of inputting data for the document has been completed. For example, upon completion of a sales or registration document, the user can enter an option such as “done,” “save,” “enter,” “go,” or the like; entry of such a command can cause an application to use input from the document as input for, for example, a sales or registration process.

Programming used for implementing mapping, navigation, and input-receiving aspects of the invention may form part of the application(s) used for displaying documents (e.g., a web-based registration or leasing program) or a stand-alone program, and may be stored locally or remotely.

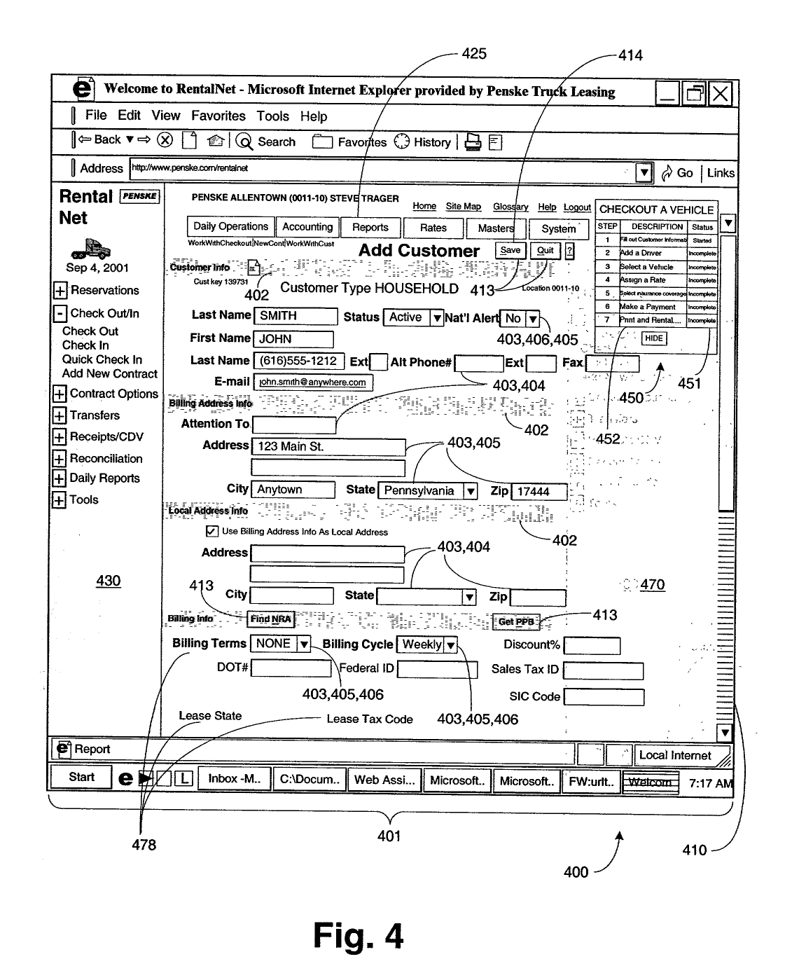

FIG. 4 is a schematic diagram of a display screen window according to a preferred embodiment of the invention. The screen shown in FIG. 4 displays a document presented as part of a commercial rental application provided via the Internet. The display screen shows both a document map and a document display.

Screen 400 of FIG. 4 comprises document display 401 and map 450, both of which are shown within the same window 410 of a display screen such as that which might be presented by a personal computer or user terminal 106 as shown in FIG. 1.

Document display 401 comprises both text material 402 and a plurality of input fields or input requests 403, 404, 405. Several input fields 404 are empty, indicating that the computer system has not yet received data for those data input requests, while several others 405 comprise indications that data has already been received. For example, “Address” field 403, 405 includes a data string “123 Main St”, and “Billing Terms” field 403, 405 includes data string “NONE”.

A document comprises an associated data request when the document data structure comprises data, flags, instructions, or other electronic information which causes a computer to present to a user an indication that a given type or class of data is requested. For example, a document data structure can comprise information which causes a computer to present to a user an image which comprises one or more data input fields, such as fields 403 in FIG. 4, with or without tags or other labeling indicia such as labels 478, in order to solicit the input of data for various functions.

Input may be entered in any suitable form. For example, a user may be required to type or copy data into a field 403; or a range of options may be provided by, for example, pull down menus such as those associated with input requests 406; or defaults, preferably overrideable by the user, may simply be provided.

Document display 401 also provides icons or buttons 413 for starting various related processes, such as saving all entered data, stopping, or performing other functions; or for moving to new documents.

The mapping and navigation application screen 450 shown in FIG. 4 is provided by a separate, stand-alone application running in parallel to the document application. For purposes of displaying the map 450, document 401 is displayed in such a size as to leave a margin 470 for display of the map. Map 450 comprises a column 451 of status indications and a list 452 of document identifiers. Document identifiers 452 comprise hypertext links such that selection of one of the identifiers by, for example, use of a computer mouse or other pointing device, causes document display 401 to be changed to that of the selected document. In the example shown in FIG. 4, a first page “Add Customer” of a document “Fill out Customer Information” is displayed. Text values for document identifiers can be provided by the mapping and navigation application, by reading data associated with the displayed document and provided by the document provider/application, or by the user.

Document input status indicators 451 of map 450 show the level of completion of data input to the currently mapped documents. As previously discussed, display 401 of currently displayed document “Fill out Customer Information” is partially complete; data has been entered in input request fields 403, 405. This is reflected in a status level indication 451 of “started” in map 450. Other documents have not been completed; their status is indicated as “incomplete.” Optionally, simpler status indicators, such as a check mark to indicate that a given document is completed, may be used.

Display 401 of FIG. 4 further comprises a navigation bar 425 and a navigation menu 430. Use of navigation bar 425 and/or menu 430 causes the display 401 to be replaced with a display corresponding to a different document. Navigation by selecting links shown in navigation bar 425 and/or 430 differs from selection of a comparable link 452 in map 450, however, in that selection of a link in map 450 results in saving of all data entered in the current document prior to display of the selected page. This can be equivalent to selection of “SAVE” icon 414 and of a link in navigation bar 425 or menu 430, except that upon selection of a link 452 data can be saved under the control of, and in a manner and at addresses designated by, the mapping and navigation application, whereas selection of “SAVE” icon 414 causes data to be saved by the document application. Navigation by use of menu 430 on the left of the display risks losing data while navigating, depending upon particulars of the rental application.

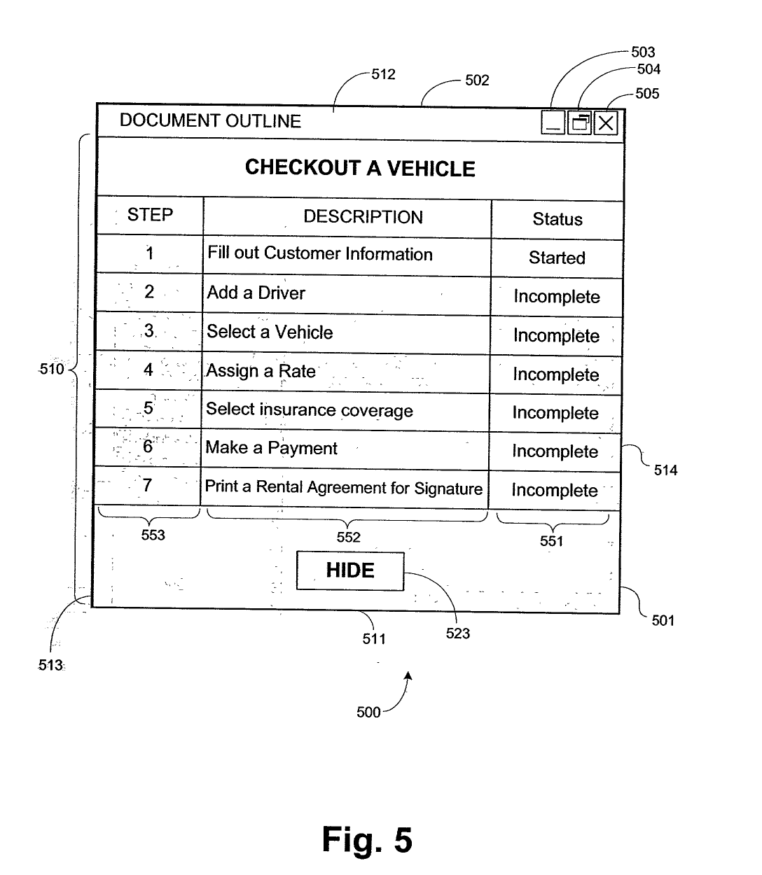

FIG. 5 is a schematic diagram of a mapping and navigation window according to a preferred embodiment of the invention. Map 500 is displayed in a distinct window 501 which comprises utility bar 502 and display portion 510. Utility bar 502 comprises icons 501, 502, 503, which, when selected by a user using a computer pointing device or other input/output device such as a keyboard, cause the computer to modify the display of map 500 in various ways commonly enabled by operating systems such as Microsoft Windows. Minimization/restoration icon 503 causes display portion 510 of map 500 to be removed from the computer display, and replaces utility bar 502 with a similar bar of reduced size, or by an icon such as a graphic device which is generally of substantially reduced size, the bar or icon being presented on the computer screen. The window can be restored to its former display state by reselecting icon 503 while the window is in its minimized state. Maximization icon 504 causes the size of the map display 500 to be stretched to occupy a full display area of the computer display, generally by enlarging the window display size both vertically and horizontally. As is common in Windows-compatible displays, the content of map window 501 can be enlarged to fill the window, so that the same content is shown, but in an enlarged size, or the size of the displayed content can remain the same and a portion of the content shown be enlarged. Quit icon 505 causes the map/navigation application to close and removes window 501 from the display completely. Optionally window 501 can be moved on the display screen by selecting a portion of utility bar 502 and moving it to a desired position on the display screen; and can be stretched vertically by selecting and moving (“dragging”) edges 511, 512, or horizontally by selecting and moving edges 513, 514, in standard windows fashion; or both, by selecting and dragging one any of the four corners of the window.

The content of window 501 of FIG. 5 is generally similar to map 450 of FIG. 4, except that window 501 selectively “floats” on top of the display screen; that is, it is, at the option of the user, always displayed in its entirety, no matter what operations are performed on other windows displayed on the screen. Floating functionality is overrideable by the user by selection of “HIDE” icon 523.

In column 552 document identifiers are presented; in column 551 are shown document input status indicators. These columns display the same information shown in map 450 in FIG. 4. In column 553 optional information regarding contingency between the documents is shown. For example, a document may be required, by the application that produces it, to be completed in a specified order. This can be shown by displaying the “steps” of column 553 and/or by displaying identifiers 552 in different colors, fonts, etc., when they are accessible and not accessible. Likewise, documents which have been displayed, which are currently displayed, or which have not been displayed, can be shown in different colors, fonts, etc.

It will be understood that the systems, media, and programming referenced herein include, either explicitly or implicitly, software implemented on computers or other appropriate hardware, including such other intelligent data processing devices having a processor, data storage means, and the ability to support an operating system, with or without user interfaces, for example, file servers, as may be useful in achieving the objectives of this invention.

Software components and applications embodying the invention can be distributed in electronic bit storage on magnetic, optical, bubble, or other media, and optionally in transportable form to be interactive with an electronic reading device, for example, on computer or optical diskettes, or may be distributed over wired or wireless networks for storage by the recipient on such media.

It will further be appreciated that such media-stored software constitutes an electronic customizing machine which can interact with a magnetically or optically cooperative computer-based input device enabling the computer to be customized as a special purpose computer, according to the contents of the software. To cause a computer to operate in such a customized, special-purpose mode, the software of the invention can be installed by a user or some other person, and will usually interact efficiently with the device on which it resides to provide the desired special-purpose functions or qualities, but only after the selection of a certain set of configuration parameters. When so configured, the special-purpose computer device has an enhanced value, especially to the professional users for whom it may be intended.

While the invention has been described and illustrated in connection with preferred embodiments, many variations and modifications as will be evident to those skilled in the art may be made without departing from the spirit and scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In many cases the order of process steps may be varied without changing the purpose, effect, or import of the methods described.

What is claimed is:

1. A computer readable medium or media having computer programming stored thereon for causing a computer system to:
display on a computer display a map of a plurality of related electronic documents, the documents comprising a plurality of associated data input requests; the map comprising an indication of the status of the data input requests.

2. The computer readable medium or media of claim 1, comprising programming stored thereon for causing the computer system to display the map on the display in a window distinct from any window used for input of data in response to data requests associated with the documents.

3. The computer readable medium or media of claim 2, comprising programming stored thereon for causing the computer system to always display the entirety of the window in which the map is displayed.

4. The computer readable medium or media of claim 2, comprising programming stored thereon for causing the computer system to selectively always display the entirety of the window in which the map is displayed.

5. The computer readable medium or media of claim 4, wherein the window in which the map is displayed is subject to at least one of the operations in the group consisting of moving, resizing, minimization, representation by a graphic icon, and restoration to a previous display state.

6. The computer readable medium or media of claim 1, wherein the map comprises selectable links and the medium or media comprising programming stored thereon for causing the computer system to display at least a portion of a document upon selection by a user of the computer system of a link associated with the document.

7. The computer readable medium or media of claim 6, wherein the map comprises an indication of whether each of the documents has been displayed.

8. The computer readable medium or media of claim 6, wherein the map comprises an indication that a currently-displayed document is displayed.

9. The computer readable medium or media of claim 1, wherein the indication of the status comprises an indication of the level of completion of a document with which the indication is associated.

10. The computer readable medium or media of claim 1, wherein an acceptance by the computer system of data in response to a request associated with a first document is contingent upon receipt of data in response to a request associated with a second document, and contingency is indicated in the map.

11. A computer readable medium or media having computer programming stored thereon for causing a computer system to:
display on a computer screen at least a portion of a first document, the first document comprising at least one first document data input field;
receive a data input for the at least one first document data input field;
store the received data input in memory associated with the computer system and display on the computer screen an indication of the status of completion of data input fields associated with the first document;
display at least a portion of a second document, the document comprising at least one second document data input field;
receive a second data input for the at least one second document data input field;
store the received second data input in memory associated with the computer system and display an indication of the status of completion of data input fields associated with the second document; and
display at least a portion of the first document, receipt of data received for input fields associated with the first document being indicated by the display.

12. The computer readable medium or media of claim 11, wherein the first document comprises a plurality of data input fields and the computer readable medium or media comprises programming stored thereon for causing the computer system to receive at least a third data input, the third data input for a second data input field associated with the first document.

13. The computer readable medium or media of claim 12, comprising programming stored thereon for causing the computer system to store the received third data input in memory associated with the computer system and display an updated indication of the status of completion of data input fields associated with the first document.

14. The computer readable medium or media of claim 11, wherein acceptance by the computer system of at least one data input associated with a subsequently-displayed document is contingent upon receipt by the computer system of at least one data input associated with a previously-displayed document, and the form of the display of at least one of the documents is determined by fulfillment or non-fulfillment of the contingency.

15. The computer readable medium or media of claim 11, wherein data received for the first document is still valid as input to a computer process upon the second displaying of the first document.

16. The computer readable medium or media of claim 15, wherein the computer system comprises a server and a user terminal, the server and user terminal each having associated computer memories, and data used by the system for displaying the first and second documents are stored in computer memory associated with the server; and
the computer readable medium or media comprises programming stored thereon for causing the computer system to store data inputs received for the first and second documents in computer memory associated with the user terminal until all required data inputs have been received, and thereafter to store the data inputs in computer memory associated with the server.

17. In a computer system useable for inputting of data for use with electronic documents, the improvement comprising computer readable medium or media having computer programming stored thereon for causing a computer system to:
display on a user computer display a map of an electronic document set, the document set comprising a plurality of documents;
display on the computer display at least a portion of a first document of the document set, the first document comprising at least one data input field;
receive a data input for at least one of the data input fields associated with the first document;
store the received data input in memory associated with the computer system;
display in association with the map an indication of the status of completion of data input fields associated with the first document;
display at least a portion of a second document, the document comprising at least one associated data input field;
receive a data input for the at least one data input field associated with the second document;
store the received data input in memory associated with the computer system; display an indication of the status of completion of data input fields associated with the second document;
display in association with the map an indication of the status of completion of data input fields associated with the second document; and
display at least a portion of the first document, receipt of data received for input fields associated with the first document being indicated by the display.

18. The improvement of claim 17, wherein the computer readable medium or media comprises programming stored thereon for causing the computer system to display the map on the display in a window distinct from any window used for input of data in response to data requests associated with the documents.

19. The improvement of claim 18, wherein the computer readable medium or media comprises programming stored thereon for causing the computer system to always display the entirety of the window in which the map is displayed.

20. The improvement of claim 18, wherein the computer readable medium or media comprises programming stored thereon for causing the computer system to selectively always display the entirety of the window in which the map is displayed.

21. The improvement of claim 20, wherein the window in which the map is displayed is subject to at least one of the operations in the group consisting of moving, resizing, representation by a graphic icon, and restoration to a previous display state.

22. The improvement of claim 17, wherein the map comprises selectable links and the medium or media comprises programming stored thereon for causing the computer system to display at least a portion of a document upon selection by a user of the computer system of a link associated with the document.

23. The improvement of claim 22, wherein the map comprises an indication of whether each of the documents has been displayed.

24. The improvement of claim 22, wherein the map comprises an indication that a currently-displayed document is displayed.

25. The improvement of claim 17, wherein the indication of the status comprises an indication of the level of completion of a document with which the indication is associated.

26. The improvement of claim 17, wherein acceptance by the computer system of data in response to a request associated with a first document is contingent upon receipt of data in response to a request associated with a second document, and contingency is indicated in the map.

27. The improvement of claim 17, wherein data received for the first document is still valid as input to a computer process upon the second displaying of the first document.

28. The improvement of claim 27, wherein the computer system comprises a server and a user terminal, the server and user terminal each having associated computer memories, and data used by the system for displaying the first and second documents are stored in computer memory associated with the server; and
the computer readable medium or media comprises programming stored thereon for causing the computer system to store data inputs received for the first and second documents in computer memory associated with the user terminal until all required data inputs have been received, and thereafter to store the data inputs in computer memory associated with the server.

29. A computer system useable for mapping, navigating, and receiving input for electronic documents, the system comprising:
means for displaying on a computer display a map of a plurality of related electronic documents, the documents comprising a plurality of associated data input requests, and the map comprising an indication of the status of the data input requests.

30. The system of claim 29, comprising means for displaying the map on the display in a window distinct from any window used for input of data in response to data requests associated with the documents.

31. The system of claim 30, comprising means for causing the computer system to always display the entirety of the window in which the map is displayed.

32. The system of claim 31, comprising means for causing the computer system to selectively always display the entirety of the window in which the map is displayed.

33. The system of claim 29, wherein the window in which the map is displayed is subject to at least one of the operations in the group consisting of moving, resizing, representation by a graphic icon, and restoration to a previous display state.

34. The system of claim 29, wherein the map comprises selectable links and the computer system comprises means for causing the computer system to display at least a portion of a document upon selection by a user of the computer system of a link associated with the document.

35. The system of claim 34, wherein the map comprises an indication of whether each of the documents has been displayed.

36. The system of claim 34, wherein the map comprises an indication that a currently-displayed document is displayed.

37. The system of claim 29, wherein the indication of the status comprises an indication of the level of completion of a document with which the indication is associated.

38. The system of claim 29, wherein acceptance by the computer system of data in response to a request associated with a first document is contingent upon receipt of data in response to a request associated with a second document, and contingency is indicated in the map.

39. A computer system useable for mapping, navigating, and receiving input for electronic documents, the system comprising:
means for displaying on a computer screen at least a portion of a first document, the first document comprising at least one first document data input field;
means for receiving a data input for the at least one first document data input field;
means for storing the received data input in memory associated with the computer system and displaying on the computer screen an indication of the status of completion of data input fields associated with the first document;
means for displaying at least a portion of a second document, the document comprising at least one second document data input field;
means for receiving a second data input for the at least one second document data input field;
means for storing the received second data input in memory associated with the computer system and display an indication of the status of completion of data input fields associated with the second document; and
means for displaying at least a portion of the first document, receipt of data received for input fields associated with the first document being indicated by the display.

40. The system of claim 39, wherein the first document comprises a plurality of data input fields and the system comprises means for causing the computer system to receive at least a third data input, the third data input for a second data input field associated with the first document.

41. The system of claim 40, comprising means for causing the computer system to store the received third data input in memory associated with the computer system and display an updated indication of the status of completion of data input fields associated with the first document.

42. The system of claim 39, wherein acceptance by the computer system of at least one data input associated with a subsequently-displayed document is contingent upon receipt by the computer system of at least one data input associated with a previously-displayed document, and the form of the display of at least one of the documents is determined by fulfillment or non-fulfillment of the contingency.

43. The system of claim 39, wherein data received for the first document is still valid as input to a computer process upon the second displaying of the first document.

44. The system of claim 43, wherein the computer system comprises a server and a user terminal, the server and user terminal each having associated computer memories, and data used by the system for displaying the first and second documents are stored in computer memory associated with the server; and
the system comprises means for causing the computer system to store data inputs received for the first and second documents in computer memory associated with the user terminal until all required data inputs have been received, and thereafter to store the data inputs in computer memory associated with the server.
